(19) United States
(12) Patent Application Publication
(10) Pub. No.: US 2008/0075095 A1
(43) Pub. Date: Mar. 27, 2008

(54) Method and system for network communication

(75) Inventors: Lalitha Suryanarayana, Austin, TX (US); Michael Grannan, Austin, TX (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/525,272

(22) Filed: Sep. 21, 2006

(51) Int. Cl. H04L 12/66; H04L 12/56; H04J 3/16

(52) U.S. Cl. 370/401; 370/352; 370/466

(57) ABSTRACT

A method and system for network communication. A first content type is identified for a communication stream of a nonaggregated communication session. A target of the communication stream is identified. The communication stream is transcoded into a second content type compatible with the target. The transcoded communication stream of the nonaggregated communication session is provided to the target.

### FIELD

This application relates to a method and system to a network communication system, and more specifically to systems and methods for providing communication streams over a network.

### BACKGROUND

A communication session of one or more communication streams may be provided among several communication devices. When a communication session of multiple communication streams is recorded, the communication session is usually recorded as an aggregated communication stream selected from the multiple communication streams (e.g., selecting portions the multiple communication streams where a person is speaking as the aggregated communication stream). An aggregated communication session including the aggregated communication stream may be recorded for subsequent viewing.

The communication sessions typically occur over a network such as an Internet protocol (IP) based network, and between compatible communication devices. Compatible communication devices typically include video conferencing devices made by a single manufacturer or devices that use an identical protocol and format. However, non-compatible communication devices are generally unable to communicate with other non-compatible communication devices.

### BRIEF DESCRIPTION OF DRAWINGS

Embodiments are illustrated by way of example and not limitation in the figures of the accompanying drawings, in which like references indicate similar elements and in which:

FIG. 1 is a block diagram of a system for network communication in accordance with an example embodiment;

FIG. 2 is a block diagram of a system for network communication in accordance with an example embodiment;

FIG. 3 is a block diagram of an example communication session;

FIG. 4 is a block diagram of an example communication session;

FIG. 5 is a block diagram of an example communication session;

FIG. 6 is a block diagram of an example communication device;

FIG. 7 is a flowchart illustrating a method of implementing a communication session in accordance with an example embodiment;

FIG. 8 is a flowchart illustrating a method of providing a communication stream in accordance with an example embodiment;

FIG. 9 is a flowchart illustrating a method of conducting a communication session in accordance with an example embodiment;

FIG. 10 is a flowchart illustrating a method of obtaining a communication stream in accordance with an example embodiment;

FIG. 11 is a flowchart illustrating a method of reproducing a stored communication session in accordance with an example embodiment;

FIG. 12 is a flowchart illustrating a method of modifying session parameters in accordance with an example embodiment;

FIG. 13 is a flowchart illustrating a method of storing communication streams of a communication session in accordance with an example embodiment;

FIG. 14 is an example user interface of a communication device;

FIG. 15 is an example user interface of a communication device;

FIG. 16 is an example annotation window;

FIG. 17 illustrates a diagrammatic representation of machine in the example form of a computer system within which a set of instructions, for causing the machine to perform any one or more of the methodologies discussed herein, may be executed;

FIG. 18 is an example communications infrastructure;

FIG. 19 is an example transcoder;

FIG. 20 is an example network appliance; and

FIG. 21 is a block diagram of an example communication device.

### DETAILED DESCRIPTION

Example methods and systems for network communication are described. In the following description, for purposes of explanation, numerous specific details are set forth in order to provide a thorough understanding of example embodiments. It will be evident, however, to one skilled in the art that the present invention may be practiced without these specific details.

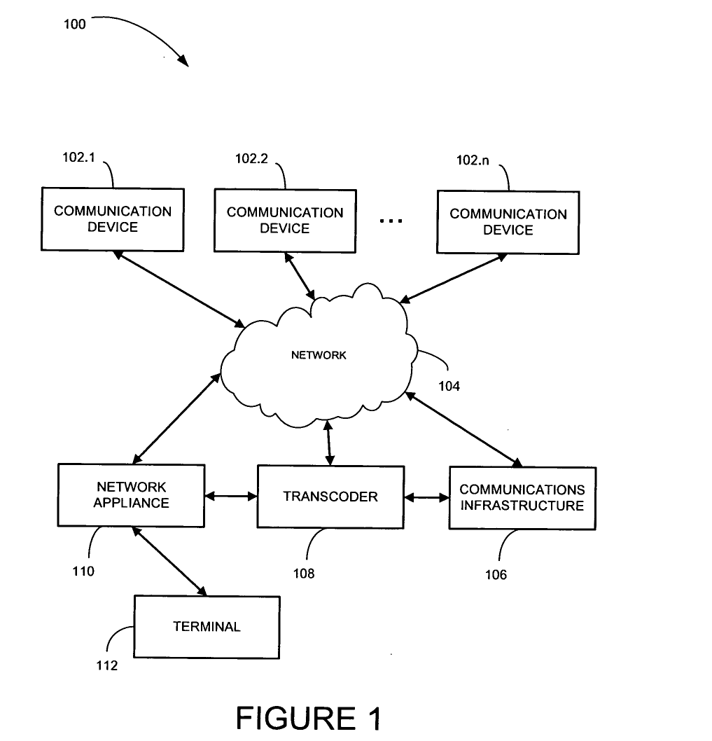

Referring to FIG. 1, an example embodiment of a system 100 for network communication is illustrated. A number of communication devices 102.1-102.n (e.g., a plurality of communication devices) may communicate over a network 104 with a communications infrastructure 106.

The communication devices 102.1-102.n may include devices capable of transmitting, receiving and/or reproducing communication streams. For example, the communication devices 102.1-102.n may be a group of resources including mobile devices and computing systems such as mobile telephones, personal digital assistants (PDAs), gaming devices, set top boxes (STBs), and the like. The communication devices 102.1-102.n may include a computing system with a media client, such as a Microsoft Windows compatible communication device running NetMeeting or CUSeeMe. The communication devices 102.1-102.n may include an IP STB that is voice over internet protocol (VoIP) enabled. The communication devices 102.1-102.n may include a standard single line telephone, a multi-line telephone, a video phone, and the like.

In an example embodiment, the communication devices 102.1-102.n may include internet protocol (IP) network enabled devices. For example, the communication devices 102.1-102.n may include proprietary devices that are typically compatible only with certain other devices, such as devices offered for sale by Polycom and Tandberg. The system 100 may limit the communication devices 102.1-102.n to the communication devices 102.1-102.n that are authorized for use by a provider (e.g., a telecommunications company).

The network 104 may include a private network (e.g., a home or business network), a public network such as the Internet, an access network, or combinations of the private network, the public network and/or the access network. The network 104 may include a wired network such as a fiber, DSL, coaxial, and the like or a wireless network such as 802.11, BLUETOOTH network, mobile cellular, WiMAX, WiFi, and the like. In an example embodiment, the network 104 may transmit data by network based protocols such as TCP/IP and UDP/IP.

In an example embodiment, the network 104 may include a home network, a service provider network, and/or other types of local area network (LAN) and wide area network (WAN).

The communication devices 102.1-102.n may, by way of example, use a session initiation protocol (SIP) to communicate over the network 104. The communication devices 102.1-102.n may use VoIP, wireless voice-over internet protocol (VoFI), or other communication protocols to communicate over the network 104.

The communications infrastructure 106 may include infrastructure to enable communication sessions such as a video communication session. The communications infrastructure 106 may be embodied in a computing system and include a network-based infrastructure that may be used across different applications and with different extensions. For example, the communications infrastructure 106 may include an IP communications infrastructure and may include SIP capability. The communications infrastructure 106 may include SIP proxies, application servers, softswitch with SIP registries/ENUM, presence servers and IP multimedia systems (IMS) architecture, and the like, which may enable one and/or multi-party communication sessions in the form of a video call and/or video multimedia real-time session.

In an example embodiment, the communications infrastructure 106 may initiate a nonaggregated communication session with two or more communication streams (e.g., available communication streams) between a signal source (e.g., a communication device 102) and one or more targets (e.g., a communication device 102 or a network appliance 110), where each of the available communication streams may be received by the communication device 102.

A transcoder 108 may receive one or more communication streams from the communications infrastructure 106 and transcode communication stream from a first content type into a second content type compatible with a target (e.g., a communication device 102.1-102.n or the terminal 112). The transcoder 108 may be embodied in a computing system and may convert formats of the communication streams as needed to work with the system 100. For example, the transcoder 108 may convert from G.723 to G.711, MP3 and H.504 to H.503 and/or H.324M, and/or for a specific quality of service.

In an example embodiment, the communications infrastructure 106 and the transcoder 108 may be embodied in separate computing systems and/or in a same computing system.

The transcoder 108 may make the communication streams into a H.503 codec compatible communication stream format, a H.504 codec compatible communication stream format, or any other codec compatible communication stream format.

The transcoder 108 may identify characteristics of the communication stream, by way of example, to identify a format and a protocol of the communication stream that may be used for conversion. For example, the transcoder 108 may convert one or more communication streams from a first type communication stream to a second type communication stream, such that the second type communication stream is compatible with the communication devices 102.1-102.n or a network appliance 110 that receives the second type communication stream. The conversion may occur in real-time.

In an example embodiment, the transcoder 108 may be invoked and perform various video format conversions that may be used in establishing a multi-way communication session. For example, if a user A is calling a user B, the user B may initiate another leg of the call with the transcoder and a handshake would take first such that the user A and the user B both can talk through the transcoder 108 and a three-way call may be established.

The communications infrastructure 106 may communicate over the network 104 with the transcoder 108. For example, the communications infrastructure 106 may be coupled to the transcoder 108. The transcoder 108 may ease communication among the communication devices 102.1-102.n that otherwise would be either unable to communicate or could communicate only after significant setup and/or configuration. The use of the transcoder 108 and the communications infrastructure 106 may enable seamless communication among the communication devices 102.1-102.n.

The transcoder 108 may act as a media conversion gateway capable of transcoding multi-media formats to support editing, viewing and/or copying the communications streams of the communication session.

In an example embodiment, a network appliance 110 may be used directly by the communications infrastructure 106 or indirectly by the network appliance 110 through the transcoder 108 for recording and storing communication streams of the communication sessions. For example, the network appliance 110 may include digital media such as a compact disc (CD) digital virtual disc (DVD) and the like, a server such as a POLYCOM server, a digital video recorder (DVR), a storage area network (SAN), a digital trunk, a home media server, and the like.

The network appliance 110 may store the communication streams when indicated by the communication devices 102.1-102.n, the terminal 112, and/or the network appliance 110. The network appliance 110 may store the one or more communications streams of the communication session in a single content format (e.g., a default storage format), in an original stream format, and/or in a transcoded format. For example, the network appliance 110 may record communication streams in a common format rather than keep multiple formats and/or a format that was specifically needed for consumption on the communication devices 102.1-102.n. The network appliance 110 may be accessible to the communication devices 102.1-102.n over the network 104, and/or may be accessible locally to the communication devices 102.1-102.n.

In an example embodiment, a terminal 112 may interface with the network appliance 110. For example, the terminal 112 may provide an interface to edit, tag and/or annotate the communication session. The plurality of communication devices 102.1-1-2.n may interface with the network appliance 110 over the network 104. In an example embodiment, the communication devices 102.1-102.n may provide an interface to edit, tag and/or annotate the communication session.

In an example embodiment, a SIP multimedia call may be established between two or more communication devices 102 with a session description protocol (SDP) and a real time protocol (RTP). The communication stream may flow through the RTP protocol to a media server of the communications infrastructure 106 and the handshaking of the communication devices 102.1-102.n on the capabilities of the communication devices and the protocols supported by the communication devices 102.1-102.n may be done during a session establishment phase through the SDP session description protocol within the communications infrastructure 106.

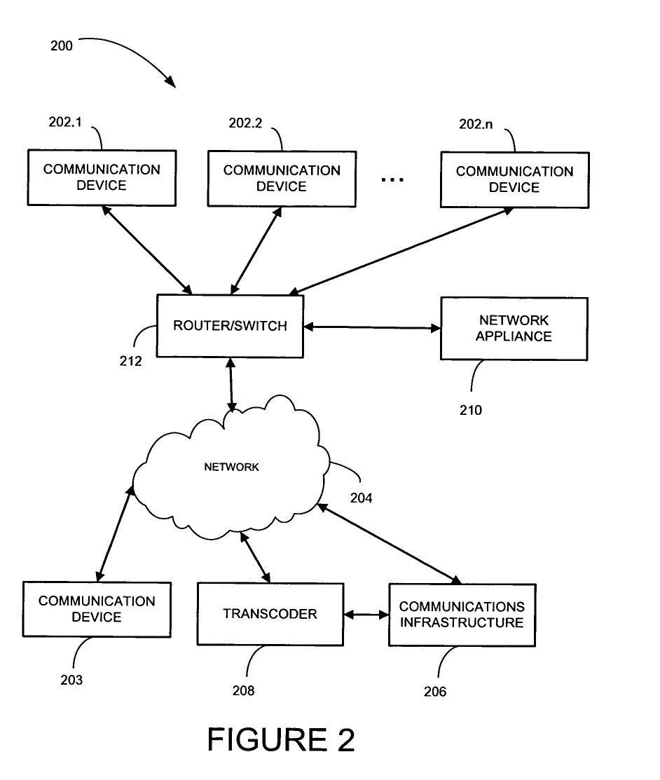

Referring to FIG. 2, an example embodiment of a system 200 for network communication is illustrated. A number of local communication devices 202.1-202.n may communicate over a network 204 through a router/switch 212. In an example embodiment, the local communication devices 202.1-202.n may include the functionality of the communication devices 102.1-102.n (see FIG. 1). In an example embodiment, the network 204 may include the functionality of the network 104 (see FIG. 1).

The router/switch 212 may direct data between the local communication devices 202.1-202.n, to a network appliance 210 and over the network 204. In an example embodiment, the functionality of the network appliance 210 may include the functionality of the network appliance 110 (see FIG. 1).

One or more remote communication devices 203 may communicate with the communication devices 202.1-202.n and the network appliance 210 through the network 204 by use of a communications infrastructure 206. In an example embodiment, the functionality of the communications infrastructure 206 may include the functionality of the communications infrastructure 106 (see FIG. 1).

The communications infrastructure 206 may use a transcoder 208 to transcode communication streams for reception by communication devices 202.1-202.n, 203 and the network appliance 210. In an example embodiment, the functionality of the transcoder 208 may include the functionality of the transcoder 108 (see FIG. 1).

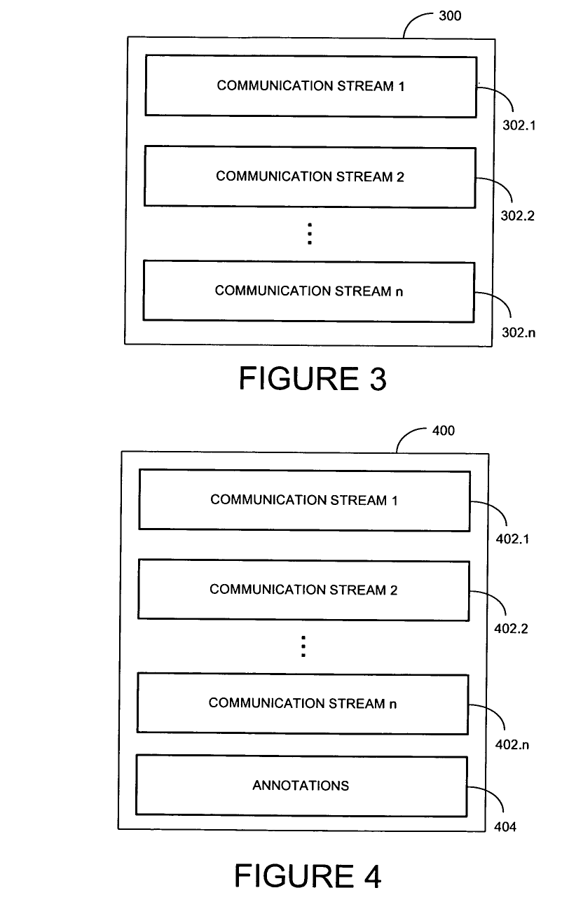

Referring to FIG. 3, an example communication session 300 is illustrated. The communication session may occur between the communication devices 102.1-102.n, 202.1-202.n, 203 and/or the network appliance 110, 210 (see FIGS. 1 and 2). The communication session 300 may include one or more communications streams of a lecture, a conversation, a conference between two or more parties, a performance, instant messaging, and the like.

The communication session 300 may be live or pre-recorded and made available through electronic mail, streaming, downloading podcasting, blogs, searches, and the like. In an example embodiment, the communication session 300 may be subject to security and/or privacy constraints to limit the ability for participants to join a live communication session 300 or reproduce a stored communication session 300.

A communication format of the communication session 300 may be independent of the associated layout and capabilities of the communication devices 102.1-102.n (see FIG. 1). For example, the communication session 300 may use synchronized multimedia integration language (SMIL) to provide spatial markup and temporal markup to enable presentation of the communication session 300 as desired on the communication devices 102.1-102.n.

The communication session 300 may include a number of communication streams 302.1-302.n. Each of the communication streams 302.1-302.n may be audio and/or video (e.g., as may be communicated from a source to one or more targets). For example, the communication streams 302.1-302.n may be transmitted in real-time to the communication devices 102.1-102.n and/or the network appliance 110 (see FIG. 1).

The communication streams may include timing information such that the communications streams 302.1-302.n when reproduced may be time synchronized. For example, the communication streams 302.1-302.n may include a video communication stream, an audio communication stream, or an audio/video communication stream. In an example embodiment, the communication streams 302.1-302.n may include MPEG4 streams.

In an example embodiment, the communication session 300 may be a nonaggregated communication session 300 where each of the communication streams 102.1-102.n of the nonaggregated communication session 300 may be accessible by and/or stored on a single communication device 102, 202, 203 and/or the network appliance 110, 210.

Referring to FIG. 4, an example communication session 400 is illustrated. The communication session 400 may include one or more communication streams 402.1-402.n respectively associated with a number of annotations 404. In an example embodiment, the functionality of the communication session 400 may include the functionality of the communication session 300 (see FIG. 3). In an example embodiment, the functionality of the communication streams 402.1-402.n may include the functionality of the communication streams 302.1-302.n (see FIG. 3).

The annotations 404 may include semantic information regarding the communication session 400. For example, the annotations 404 may include metadata, hyperlinks, chapter headings, topics, audio and the like.

In an example embodiment, the annotations 404 may enable a user to select a position in the communication streams 402.1-402.n. In an example embodiment, the annotations 404 may provide textual information to a user regarding the communication session 400. For example, processing the annotations 404 live or during playback may enable a customized experience (e.g., control over appearance of the communications streams 402.1-402.n) on the communication devices 102.1-102.n, 202.1-202.n of FIGS. 1 and 2 in response to the annotations 404 in conjunction with the communication streams 402.1-402.n.

In an example embodiment, the annotations 404 may enable portions of the communication session 400 to be parsed and categorized for later searching and access. For example, semantic ontologies may be developed for the annotations that enable queries via extensible markup language (XML). The annotations 404 may enable a user to branch to portions of the communication session 400 including between the communication streams 402.1-402.n.

In an example embodiment, the annotations 404 may be added to the communication session 400 using synchronized multimedia integration language (SMIL), video annotation markup language (VAML), and other implementations that enable the addition of the annotations 404.

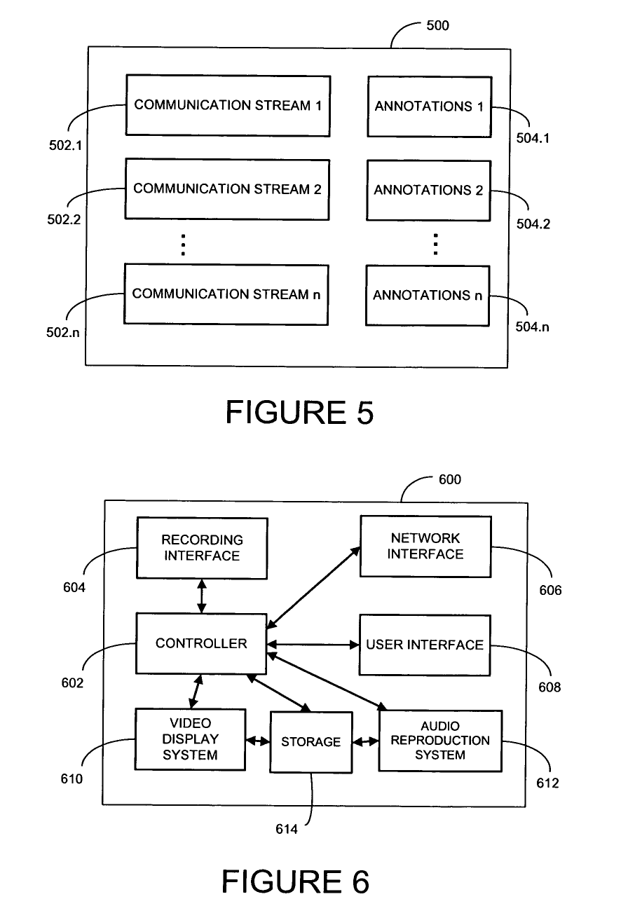

Referring to FIG. 5, an example communication session 500 is illustrated. The communication session 500 may include one or more communication streams 502.1-502.n. In an example embodiment, the functionality of the communication session 500 may include the functionality of the communication session 300 (see FIG. 3). In an example embodiment, the functionality of the communication streams 502.1-502.n may include the functionality of the communication streams 302.1-302.n.

A number of annotations 504.1-504.n may each respectively be associated with the communication streams 502.1-502.n. In an example embodiment, the annotations 504.1-504.n may respectively be recorded and stored within the communication streams 502.1-502.n. The annotations 504.1-504.n may respectively be linked within the communication streams 502.1-502.n. The annotations 504.1-504.n may optionally include the annotations 404 (see FIG. 4).

Referring to FIG. 6, an example communication device 600 is illustrated. In an example embodiment, the functionality of the communication devices 102.1-102.n, 202.1-202.n, 203 (see FIGS. 1 and 2) may include the functionality of the communication device 600.

The communication device 600 may include a controller 602. The controller 602 may direct operations on the communication device 600. The controller 602 may be coupled to a recording interface 604, a network interface 606, a user interface 608, a video display system 610, an audio reproduction system 612 and a storage 614.

The recording interface 604 may be used to receive communication input from a user of the communication device 600. For example, audio and/or video may be recorded on the communication device 600 through use of the recording interface 604. The recording interface 604 may include a video camera, a microphone, and the like. The recording interface 604 may receive multiple communication streams 302.1-302.n, 402.1-402.n, 502.1-502.n and record the communication streams 302.1-302.n, 402.1-402.n, 502.1-502.n together optionally with the annotations 404, 504.1-504.n. In an example embodiment, the two or more communication streams may include SMIL and/or VAML to create a device independent playback format for use with the recording interface 604.

The network interface 606 may be used to communicate over the network 104, 204 (see FIGS. 1 and 2). For example, the communication streams 302.1-302.n, 402.1-402.n, 502.1-502.n (see FIGS. 3-5) may be transmitted to and from the network interface 606 over the network 104, 204.

The communication device 600 may be controlled by a user through use of the user interface 608. An example embodiment of a user interface 608 is described in greater detail below.

The user of the communication device 600 may visually perceive the communication streams 302.1-302.n, 402.1-402.n, 502.1-502.n and the annotations 404, 504.1-504.n through the video display system 610. The user of the communication device 600 may audibly perceive the communication streams and/or the annotations through the audio reproduction system 612.

The storage 614 may be used to store data, such as the communication streams 302.1-302.n, 402.1-402.n, 502.1-502.n of the communication sessions 300, 400, 500. In an example embodiment, the storage 614 may include memory, firmware, fixed disk, removable computer readable medium, and the like.

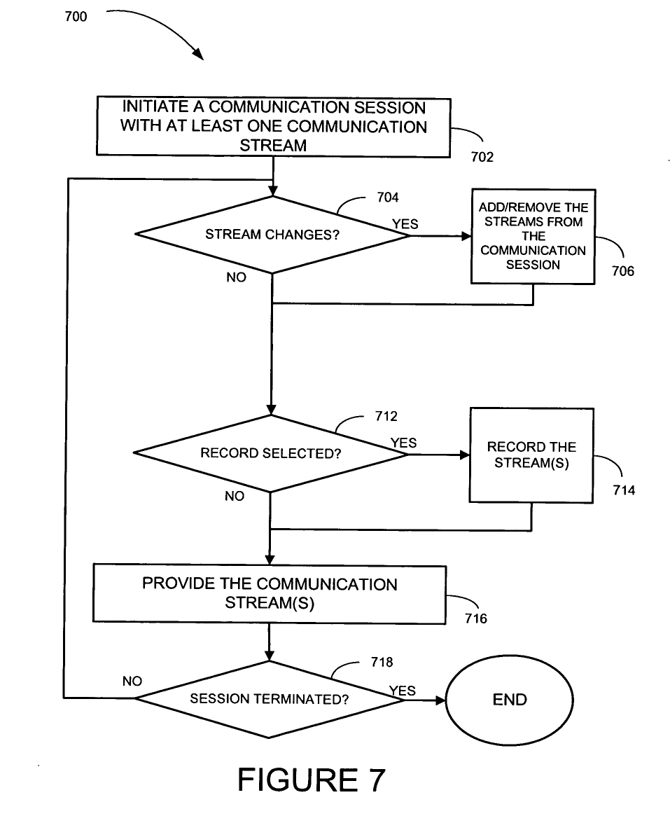

Referring to FIG. 7, a method 700 of implementing a communication session 300, 400, 500 (see FIGS. 3-5) in accordance with an example embodiment is illustrated. In an example embodiment, the method 700 may operate on the communications infrastructure 106 and/or the communications infrastructure 206 (see FIGS. 1 and 2).

The communication session 300, 400, 500 may be initiated with at least one communication stream 302, 402, 502 at block 702. In an example embodiment, the communication session 300, 400, 500 may include a single communication stream 302, 402, 502 from a first communication device 102, a single communication stream 302, 402, 502 from a first communication device 102 to a second communication device 102, two communication streams 302, 402, 502 between a first communication device 102 and a second communication device 102 and/or multiple communication streams 302.1-302.n, 402.1-402.n, 502.1-502.n between three or more communication devices 102.1-102.n.

A determination may be made at decision block 704 whether to modify the communication streams 302.1-302.n, 402.1-402.n, 502.1-502.n of the communication session 300, 400, 500. For example, the decision to modify the communication streams 302.1-302.n, 402.1-402.n, 502.1-502.n may be based on operation of the communication devices 102.1-102.n during the communication session 300, 400, 500.

If a determination is made to modify the communication streams 302.1-302.n, 402.1-402.n, 502.1-502.n of the communication session 300, 400, 500, the method 700 may add and/or remove one or more communication streams 302.1-302.n, 402.1-402.n, 502.1-502.n from the communication session 300, 400, 500 at block 706. If a determination is made not to modify the communication streams 302.1-302.n, 402.1-402.n, 502.1-502.n of the communication session 300, 400, 500 at decision block 704 or after block 706, the method 700 may proceed to decision block 712.

At decision block 712, a determination may be made whether to record the communication streams 302.1-302.n, 402.1-402.n, 502.1-502.n of the communication session 300, 400, 500. For example, the determination to record the communication streams 302.1-302.n, 402.1-402.n, 502.1-502.n may be based on a record request received from the one or more communication devices 102.1-102.n.

If the determination is made to record the communication streams 302.1-302.n, 402.1-402.n, 502.1-502.n of the communication session 300, 400, 500, the communication streams 302.1-302.n, 402.1-402.n, 502.1-502.n of the communication session 300, 400, 500 may be recorded at block 714. If a determination is made not to record the communication streams 302.1-302.n, 402.1-402.n, 502.1-502.n of the communication session 300, 400, 500 at decision block 712 or after block 714, the method 700 may proceed to block 716.

The method 700 may provide the communication streams 302.1-302.n, 402.1-402.n, 502.1-502.n to a device at block 716. The communication streams 302.1-302.n, 402.1-402.n, 502.1-502.n may be provided from a signal source (e.g., the one or more communication devices 102.1-102.n and/or the network appliance 110 of FIG. 1). The communication streams 302.1-302.n, 402.1-402.n, 502.1-502.n may be provided to one or more targets (e.g., the one or more communication devices 102.1-102 and/or the network appliance 110). In an example embodiment, the annotations 404, 504.1-504.n may be provided with the communication streams 302.1-302.n, 402.1-402.n, 502.1-502.n. In an example embodiment, nontranscoded communication streams (e.g., communication streams 302.1-302.n, 402.1-402.n, 502.1-502.n that have not been transcoded by the transcoder 108, 208) and/or transcoded communication streams of the plurality of communication streams 302.1-302.n, 402.1-402.n, 502.1-502.n may be provided.

At decision block 718, the method 700 may determine whether the session has been terminated. For example, the method 700 may terminate when there are no more remaining communication streams 302.1-302.n, 402.1-402.n, 502.1-502.n in the communication session 300, 400, 500. If a determination is made not to terminate, the method 700 may return to decision block 704. If a determination is made to terminate the sessions, the method 700 may terminate.

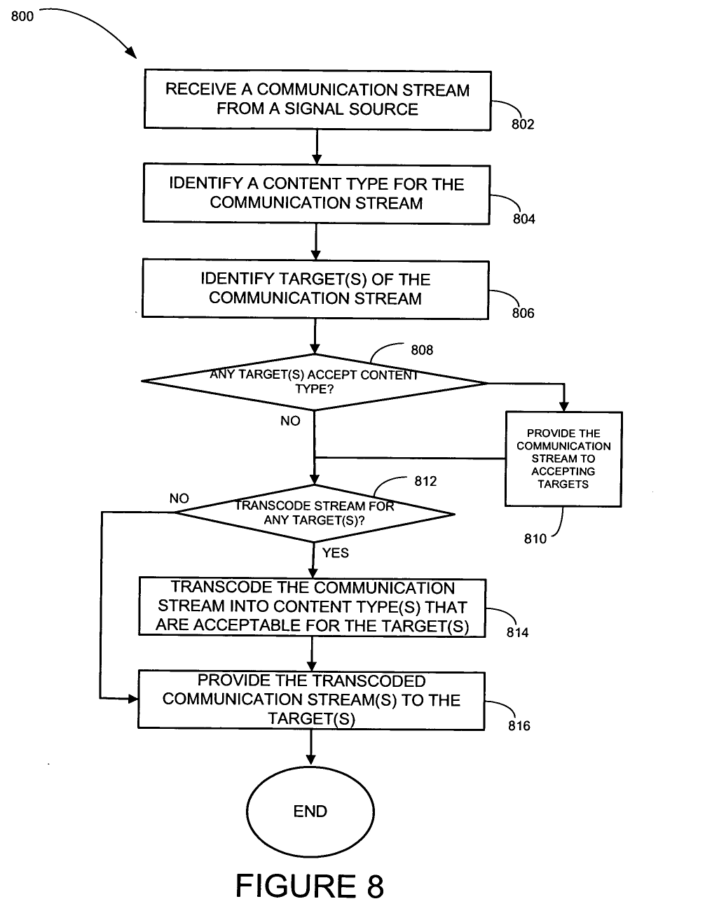

Referring to FIG. 8, a method 800 of providing a communication stream 302, 402, 502 (see FIGS. 3-5) in accordance with an example embodiment is illustrated. In an example embodiment, the method 800 may operate on the communications infrastructure 106 (see FIG. 1). In an example embodiment, the method 800 may be performed at block 716.

The communication stream 302, 402, 502 may be received from a signal source (e.g., the communication device 102 or the network appliance 110) at block 802. In an example embodiment, the annotations 404, 504 may be received with the communication stream 302, 402, 502.

A content type may be identified for the communication stream 302, 402, 502 at block 804. For example, the content type may include a format and/or a protocol used with the communication stream 302, 402, 502.

One or more targets of the communication stream 302, 402, 502 may be identified at block 806. For example, the targets may include the communication devices 102.1-102.n, 202.1-202.n, 203 and/or the network appliance 110, 210.

At decision block 808, a determination may be made as to whether any of the targets accept the content type of the communication stream 302, 402, 502. For example, the targets may accept the content type if the targets are capable of receiving the communication stream 302, 402, 502 and reproducing the communication stream 302, 402, 502. If the targets are capable of accepting the content type, the communication stream 302, 402, 502 to may be provided to accepting targets at block 810. In an example embodiment, the annotations 404, 504 may be provided with the communication stream 302, 402, 502. If the targets are not capable of accepting the content type at decision block 808 or after block 810, the method 800 may proceed to decision block 812.

A determination may be made at decision block 812 whether to transcode the communication stream 302, 402, 502 for any of the targets. For example, the method 800 may elect to transcode the communication stream 302, 402, 502 if any of the targets did not receive the communication stream 302, 402, 502 at block 810.

If a determination is made to transcode the communication stream 302, 402, 502 at decision block 812, the method 800 may transcode the communication stream 302, 402, 502 into one or more content types at block 814 that may be received by the targets and the communication stream 302, 402, 502 may be reproduced. The transcoded communication streams may then be provided to the targets at block 816. In an example embodiment, the annotations 404, 504 may be provided with the transcoded communication stream 302, 402, 502.

If a determination is made not to transcode the communication stream 302, 402, 502 at decision block 812 or after completing the operations at block 816, the method 800 may terminate.

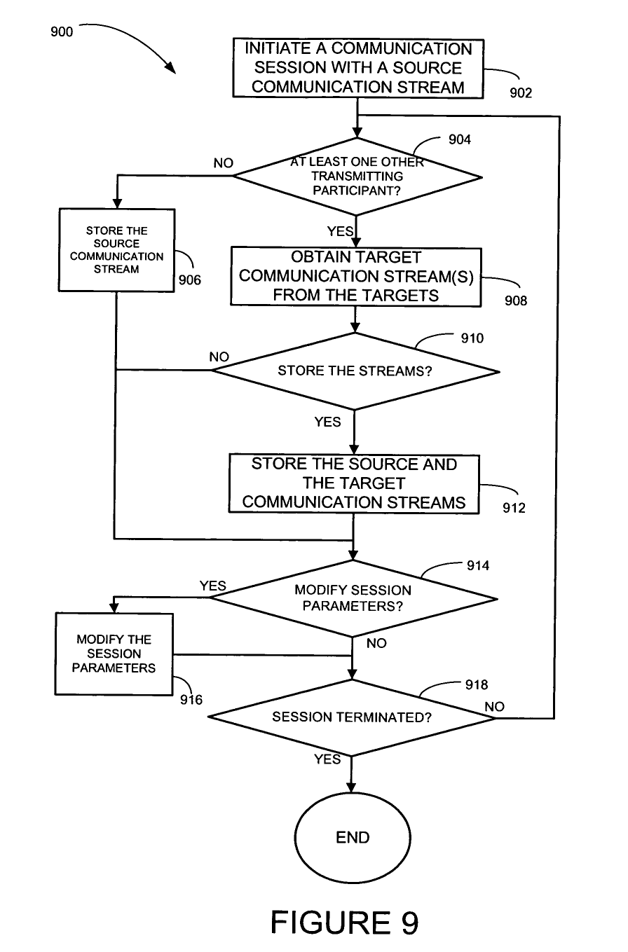

Referring to FIG. 9, a method 900 for conducting a communication session 300, 400, 500 (see FIGS. 3-5) in accordance with an example embodiment is illustrated. In an example embodiment, the method 900 may operate on a communication device 102, 202, 203 (see FIGS. 1 and 2).

The communication session 300, 400, 500 may be initiated with a source communication stream 302, 402, 502 at block 902. For example, the source communication stream 302, 402, 502 may be a communication stream 302, 402, 502 from a signal source.

At decision block 904, a determination may be made as to whether at least one other transmitting participant is involved with the communication session 300, 400, 500. For example, the transmitting participant may be a target that provides an additional communication stream 302, 402, 502.

If a determination is made that only one transmitting participant is involved (e.g., the signal source), the source communication stream 302, 402, 502 may be stored at block 906 and the method 900 may proceed to decision block 914. In an example embodiment, the annotations 404, 504 may be stored with the source communication stream 302, 402, 502. The source communication stream 302, 402, 502 may be stored on the network appliance 110 and/or the communication device 102 that is transmitting the source communication stream 302, 402, 502. After completing the operations at block 906, the method 900 may proceed to decision block 914.

If a determination is made that more than one transmitting participant is involved at decision block 904, one or more target communication streams may respectively be obtained from one or more targets at block 908. For example, the targets may include one or more communication devices 102.1-102.n and the target communication streams may include one or more communication streams 302.1-302.n, 402.1-402.n, 502.1-502.n.

At a decision block 910, a determination may be made as to whether to store the source communication stream 302, 402, 502 and the target communication streams 302, 402, 502. If a determination is made to store the source communication stream 302, 402, 502 and the target communication streams 302, 402, 502, the source communication stream 302, 402, 502 and the target communication stream 302, 402, 502 may be stored at block 912. In an example embodiment, the annotations 404, 504 may be stored with the source communication streams 302, 402, 502 and the target communication streams 302, 402, 502.

The source communication stream 302, 402, 502 and the target communication stream 302, 402, 502 may be stored on the network appliance 110 and/or on at least one of the one or more communication devices 102.1-102.n. In an example embodiment, the source communication stream 302, 402, 502 and the target communication stream 302, 402, 502 may be stored in a time synchronized and distributed manner among on at least one of the one or more communication devices 102.1-102.n.

At decision block 914, a determination may be made as to whether to modify session parameters. For example, the session parameters may include modifying stream selection, selecting automatic annotation, selecting manual annotation, accessing annotations, and the like.

If a determination is made to modify the session parameters, the session parameters may be modified at block 916. An example embodiment of modifying the session parameters is described below. If a determination is made not to modify the session parameters at decision block 914 or after completing the operations at block 916, the method 900 may proceed to decision block 918.

A determination may be made at decision block 918 whether to terminate the communication session 300, 400, 500. For example, the method 900 may terminate if the source communication stream 302, 402, 502 and the target communication streams 302, 402, 502 are removed from the communication session 300, 400, 500. If the communication session 300, 400, 500 is not terminated, the method 900 may return to decision block 904. If the communication session 300, 400, 500 is terminated at the decision block 918, the method 900 may terminate.

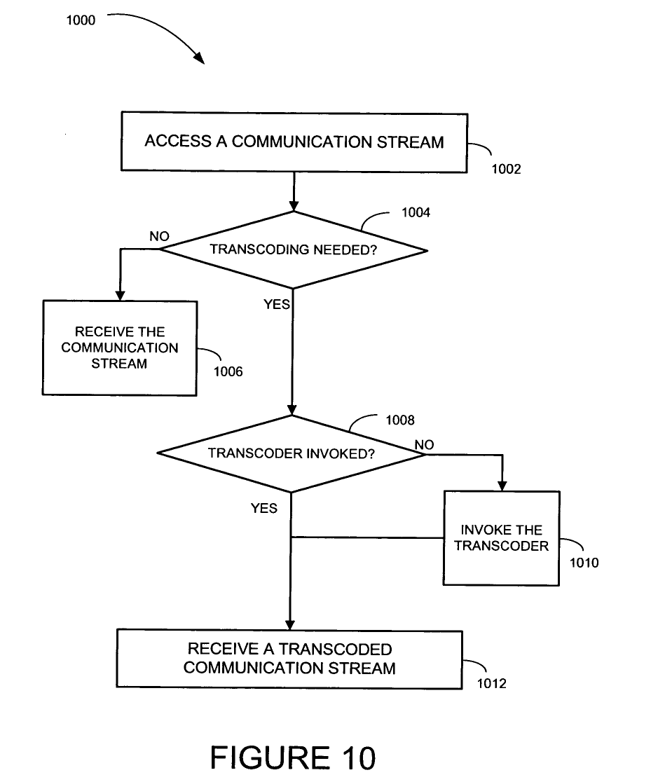

Referring to FIG. 10, a method 1000 for obtaining a communication stream 302, 402, 502 (see FIGS. 3-5) in accordance with an example embodiment is illustrated. In an example embodiment, the method 1000 may be performed on the one or more communication devices 102.1-102.n, 202.1-202.n, 203.

A communication stream 302, 402, 502 may be accessed at block 1002. For example, the communication device 102 may access the communication stream 302, 402, 502 from the communications infrastructure 106 (see FIG. 1). In an example embodiment, the annotations 404, 504 may be accessed with the communication stream 302, 402, 502.

At decision block 1004, a determination may be made as to whether transcoding is needed. For example, transcoding may be needed when the communication device 102 cannot reproduce the communication stream 302, 402, 502.

If transcoding is not needed at decision block 1004, the communication stream 302, 402, 502 may be received at block 1006. For example, the communication stream 302, 402, 502 may be received by the communication device 102, 202, 203. In an example embodiment, the annotations 404, 504 may be made available with the communication stream 302, 402, 502. If transcoding is needed at decision block 1004, the method 1000 may proceed to decision block 1008.

A determination may be made at decision block 1008 whether the transcoder 108, 208 (see FIGS. 1 and 2) has been invoked. If the transcoder 108, 208 has not been invoked, the transcoder may be invoked at block 1010. If the transcoder 108, 208 has been invoked at decision block 1008 or after completing the operations at block 1010, a transcoded communication stream may be received at block 1012. For example, the transcoded communication stream may be the communication stream 302, 402, 502 that may be reproduced by the communication device 102, 202, 203. In an example embodiment, the annotations 404, 504 may be made available with the communication stream 302, 402, 502.

After completing the operations at block 1006 or block 1012, the method 1000 may terminate.

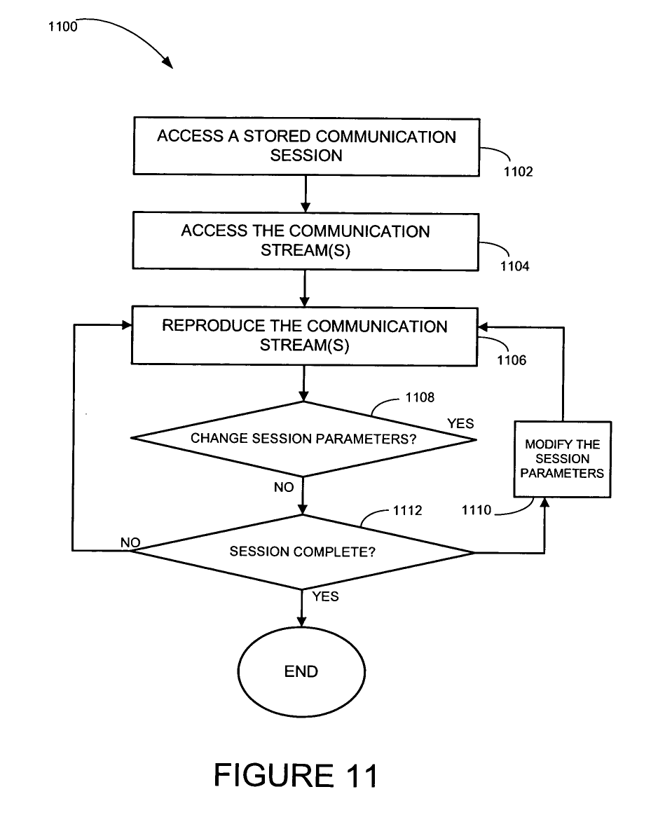

Referring to FIG. 11, method 1100 for reproducing a stored communication session 300, 400, 500 (see FIGS. 3-5) is illustrated. In an example embodiment, the method 1100 may be performed on the communication devices 102.1-102.n, 202.1-202.n, 203.

The stored communication session 300, 400, 500 may be accessed at block 1102. For example, the stored communication session 300, 400, 500 may be a communication session 300, 400, 500 stored on the network appliance 110, 210 (see FIGS. 1 and 2) and/or stored on one or more communication devices 102.1-102.n, 202.1-202.n, 203. In an example embodiment, the communication streams 302.1-302.n, 402.1-402.n, 502.1-502.n may be accessed by a communication device 102.1-102.n, 202.1-202.n, 203 and/or a user using the communication device 102.1-102.n, 202.1-202.n, 203 that was not part of an original communication session 300, 400, 500.

The communication streams 302.1-302.n, 402.1-402.n, 502.1-502.n may be accessed from the stored communication session 300, 400, 500 at block 1104. In an example embodiment, the method 1000 (see FIG. 10) may be performed at block 1104. In an example embodiment, the annotations 404, 504.1-504.n may be accessed with the communication streams 302.1-302.n, 402.1-402.n, 502.1-502.n.

The communication streams 302.1-302.n, 402.1-402.n, 502.1-502.n may be reproduced at block 1106. In an example embodiment, the annotations 404, 504.1-504.n may be made available with the communication streams 302.1-302.n, 402.1-402.n, 502.1-502.n.

At decision block 1108, a determination may be made as to whether a change to session parameters for the reproduction of the communication streams 302.1-302.n, 402.1-402.n, 502.1-502.n of the communication session 300, 400, 500 has been requested.

If the change to the session parameters has been requested at the decision block 1108, the session parameters may be modified at block 1110 and the method 1100 may return to block 1106. An example embodiment of method for modifying the session parameters is described below. If the change to the session parameters has not been requested at the decision block 1108, the method 1100 may proceed to decision block 1112.

A determination may be made as to whether the communication session 300, 400, 500 is complete at decision block 1112. For example, the communication session 300, 400, 500 may be complete when the communication streams 302.1-302.n, 402.1-402.n, 502.1-502.n have terminated.

If the communication session 300, 400, 500 is not complete at decision block 1112, the method 1100 may return to block 1106. If the communication session 300, 400, 500 is complete, the method 1100 may terminate.

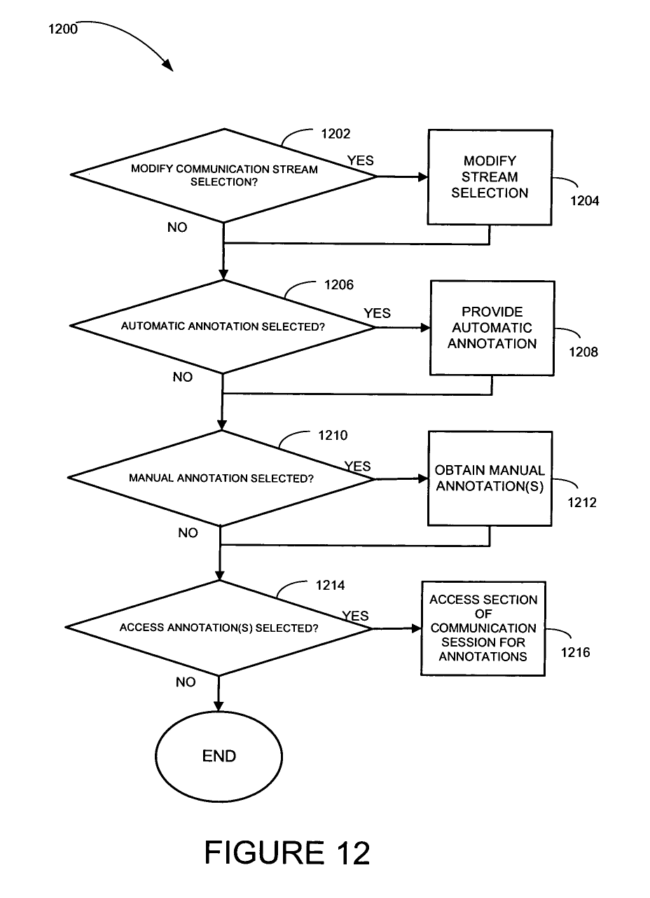

Referring to FIG. 12, a method 1200 of modifying session parameters according to an example embodiment is illustrated. In an example embodiment, the method 1200 may be performed at block 916 and/or block 1110 (see FIGS. 9 and 11).

The method 1200 may determine at decision block 1202 whether to modify selection of the communication streams 302.1-302.n, 402.1-402.n, 502.1-502.n. If the method 1200 determines to modify the selection, the selection of the communication streams 302.1-302.n, 402.1-402.n, 502.1-502.n for reproduction may be modified at block 1204. In an example embodiment, the communication devices 102.1-102.n may reproduce a single communication stream 302, 402, 502 at a time and/or multiple communication streams 302.1-302.n, 402.1-402.n, 502.1-502.n at a time. If the method 1200 does not determine to modify the selection at decision block 1202 or after block 1204, the method 1200 proceeds to decision block 1206.

At decision block 1206, the method 1200 may determine whether automatic annotation is selected. If automatic annotation is selected, the method 1200 may provide automatic annotation at block 1208. For example, annotations may be added automatically to indicate which participant is speaking at a particular time in the communication session 300, 400 500. Artificial intelligence (AI) type functionality may be used to digitally interpret the communication streams 302.1-302.n, 402.1-402.n, 502.1-502.n of the communication session 300, 400, 500 semantically (e.g., via speech and image recognition) and annotate the communication session 300, 400, 500 accordingly. If automatic annotation is not selected at decision block 1206 or after completion of the operations at block 1208, the method 1200 may proceed to decision block 1210.

The method 1200 may determine at decision block 1210 whether manual annotation has been selected. If manually annotation has been selected, the method 1200 may obtain one or more manual annotations at the block 1212. For example, the manual annotations may include a short description of what is being discussed during the communication session 300, 400, 500. If manual annotation has not been selected at decision block 1210 or after the block 1212, the method 1200 may proceed to decision block 1214.

At decision block 1214, the method 1200 may determine whether access annotations has been selected. If access annotations has been selected, the method 1200 may access the annotations of the communication streams 302.1-302.n, 402.1-402.n, 502.1-502.n at block 1216. For example, accessing the annotations may including reproducing content for one or more sections of the communication session 300, 400, 500 at block 1216 where annotations have been associated with the communication streams 302.1-302.n, 402.1-402.n, 502.1-502.n (e.g., in the appropriate format). If access annotations has not been selected at decision block 1214 or after block 1216, the method 1200 may terminate.

In an example embodiment, the method 1200 may enable a user to reproduce an entire communication session 300, 400, 500 or portions of a communication session 300, 400, 500 based on certain time information of the communication session 300, 400, 500, who was speaking during the communication session 300, 400, 500, a particular communication stream 302, 402, 502 of the communication session 300, 400, 500, topics from annotations 404, 504.1-504.n during the communication session 300, 400, 500, and the like.

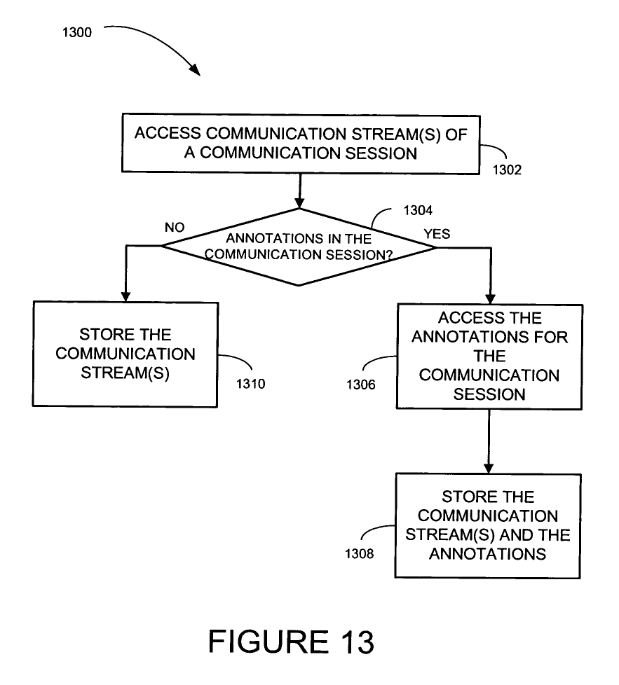

Referring to FIG. 13, a method 1300 for storing communication streams of a communication session according to an example embodiment is illustrated. In an example embodiment, the method 1300 may be performed on the communication devices 102.1-102.n, 202.1-202.n, 203 and/or the network appliance 110, 210 (see FIGS. 1 and 2).

The communication streams 302.1-302.n, 402.1-402.n, 502.1-502.n of the communication session 300, 400, 500 may be accessed at block 1302 (see FIGS. 3-5).

At decision block 1304, the method 1300 may determine whether annotations are in the communication session 300, 400, 500. If annotations are not in the communication session 300, 400, 500, the method 1300 may store the communication streams 302.1-302.n, 402.1-402.n, 502.1-502.n at block 1310.

If annotations are in the communication session 300, 400, 500 at decision block 1304, the method 1300 may access the annotations for the communication session 300, 400, 500 at block 1306. The communication streams 302.1-302.n, 402.1-402.n, 502.1-502.n and the annotations may then be stored at block 1308.

Upon completion of the operations at block 1308 or block 1310, the method 1300 may terminate.

In an example embodiment, a device used to stored the communication session 300, 400, 500 at block 1308 or block 1310 may be a pre-configured device and/or a device configured in real-time.

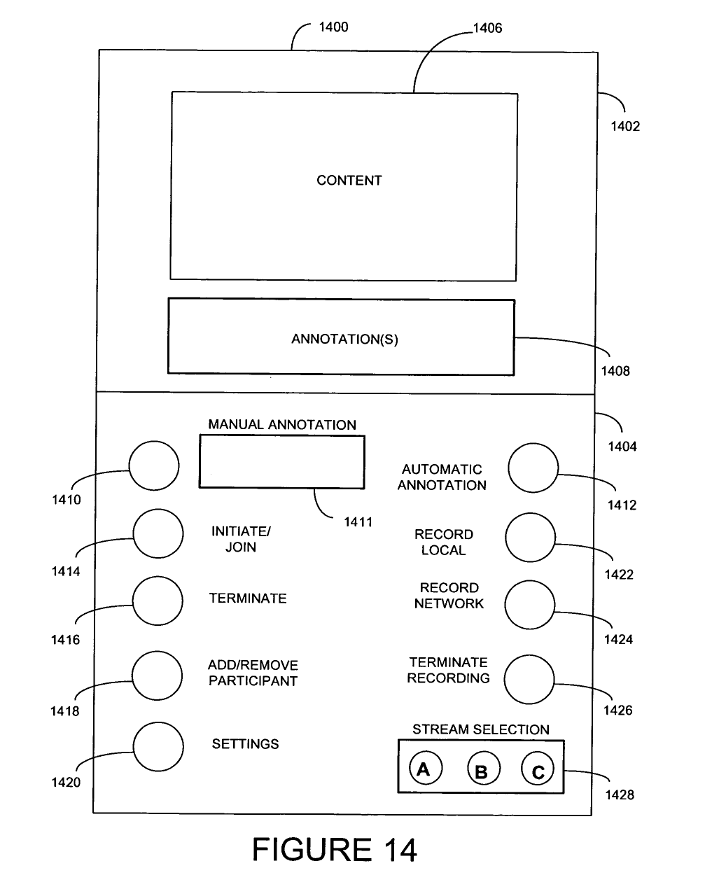

Referring to FIG. 14, a user interface 1400 in accordance with an example embodiment is illustrated. In an example embodiment, the communication devices 102.1-102.n, 202.1-202.n, 203 (see FIGS. 1 and 2) may include the user interface 1400.

The user interface 1400 may include a reproduction portion 1402 and a control portion 1404. The reproduction portion may include a content window 1406 and an annotations window 1408.

The content window 1406 may provide a visual reproduction of the communicated content. The annotations window 1408 may provide a listing of all annotations used with the content. An example embodiment of the annotations window 1408 is described in greater detail below.

The control portion 1404 may include a manual annotation selection 1410, a manual annotation window 1411 and an automatic annotation selection 1412. For example, a user of the user interface 1400 may select the manual annotation selection 1410 to add annotations manually to the communication session 300, 400, 500 and may specify the annotations 404, 504.1-504.n to be added through the manual annotation window 1411.

The automatic annotation selection 1412 may be used to add annotations 404, 504.1-504.n to the communication session 300, 400, 500 (see FIGS. 3-5) without input from a user of the user interface 1400.

The control portion 1404 may include call/accept selection 1414, terminate selection 1416, add/remove participant selection 1418 and settings selection 1420 to control operations of the communication session 300, 400, 500.

The call/accept selection 1414 may enable the user to initiate the communication session 300, 400, 500 with one or more other users and join a communication session 300, 400, 500 with one or more other users.

The terminate selection 1416 may enable the user to terminate the communication session 300, 400, 500 with one or more other users. In an example embodiment, selection of the terminate selection 1416 may terminate the user's involvement with the communication session 300, 400, 500 and/or terminate the user and the other users involvement with the communication session 300, 400, 500.

The add/remove participant selection 1418 may enable the user to invite another user to an existing communication session 300, 400, 500 or terminate another user from the existing communication session 300, 400, 500.

The settings selection 1420 may enable the user to modify the settings of the user interface 1400 or the communication device 102. For example, the settings selection 1420 may enable the user to modify the presentation of the communication streams 302.1-302.n, 402.1-402.n, 502.1-502.n in the content window 1406. In an example embodiment, the settings selection 1420 may enable the user to modify settings for the recording interface 604 (see FIG. 6) such as volume, picture quality, and the like.

The control portion 1404 may enable a user to enable and disable recording parameters through use of a record local selection 1422, a record network selection 1424, and a terminate recording selection 1450. The record local selection 1422 may enable recording of the communication session 300, 400, 500 on the communication device 102. The record network selection 1424 may enable recording of the communication session 300, 400, 500 on the network appliance 110 (see FIG. 1). The terminate recording selection 1450 may terminate a recording of the communication session 300, 400, 500.

The control portion may include a stream selection 1461. The stream selection 1461 may be used in combination with other selections 1410-1050 such as to specify action to be taken with selected communication streams 302, 402, 502. In an example embodiment, a single communication stream 302, 402, 502 may be selected by the stream selection 1461, such as to toggle reproducing the communication stream 302, 402, 502 from a particular communication device 102, 202, 203. In an example embodiment, multiple communication streams 302, 402, 502 may be selected by stream selection 1461.

In an example embodiment, the selections 1410-1461 may be implemented on the communication devices 102.1-102.n with soft and/or hard keys.

In an example embodiment, the communication devices 102.1-102.n may support SMIL. For example, the communication devices may include a client written in SMIL that incorporates the communication streams 302.1-302.n, 402.1-402.n, 502.1-502.n and annotations 404, 504.1-504.n into a user interface.

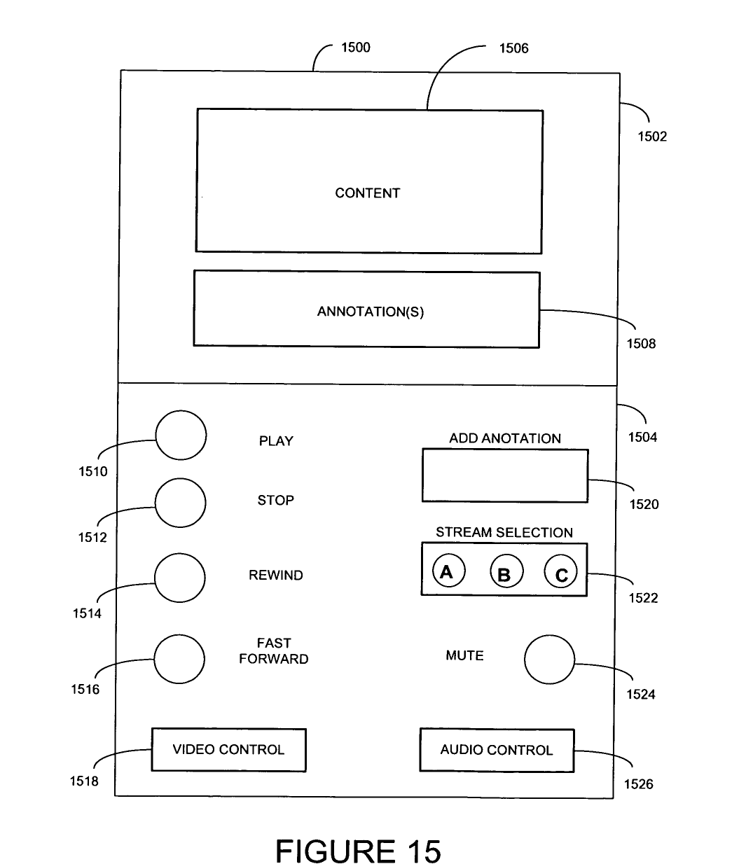

Referring to FIG. 15, a user interface 1500 in accordance with an example embodiment is illustrated. In an example embodiment, the communication devices 102.1-102.n, 202.1-202.n, 203 and/or the terminal 112 (see FIGS. 1 and 2) may include the user interface 1500.

The user interface 1500 may include a reproduction portion 1502 and a control portion 1504. The reproduction portion may include a content window 1506 and an annotations window 1508. In an example embodiment, the functionality of the content window 1506 may include the functionality of the content window 1406 (see FIG. 14) and the functionality of the annotations window 1508 may include the functionality of the annotations window 1408.

The control portion 1504 may include a play selection 1510, a stop selection 1512, a rewind selection 1514, a fast forward selection 1516 and a video control 1518. For example, the play selection 1510 may enable a user to view one or more stored communication streams 302.1-302.n, 402.1-402.n, 502.1-502.n (see FIGS. 3-5) from the communication session 300, 400, 500, stop selection 1512 may enable a user to stop viewing one or more stored communication streams 302.1-302.n, 402.1-402.n, 502.1-502.n from the communication session 300, 400, 500, rewind selection 1514 may enable a user to rewind the stored communication streams 302.1-302.n, 402.1-402.n, 502.1-502.n from the communication session 300, 400, 500, fast forward selection 1516 may enable a user to fast forward the stored communication streams 302.1-302.n, 402.1-402.n, 502.1-502.n from the communication session 300, 400, 500. For example, portions of the control portion 1504 may be implemented by a third party content player such as Windows Media Player, Real player, QuickTime and the like.

In an example embodiment, the video control 1518 may provide ongoing tracking of time of the communication session 300, 400, 500. In an example embodiment, the video control 1518 may enable a user to jump to a certain position in the communication streams 302.1-302.n, 402.1-402.n, 502.1-502.n of the communication session 300, 400, 500.

Add annotation window 1520 of the control portion may enable a user to add one or more annotations 404, 504.1-504.n to the communication session 300, 400, 500.

The control portion 1504 may include a stream selection 1522. The stream selection 1522 may be used in combination with other selections, controls and window 1510-1520, 1524, 1550 such as to specify action to be taken with selected communication streams 302.1-302.n, 402.1-402.n, 502.1-502.n. In an example embodiment, a single communication stream 302, 402, 502 may be selected by stream selection 1522. In an example embodiment, multiple communication streams 302, 402, 502 may be selected by stream selection 1522.

The mute selection 1524 and audio control 1550 of the control portion 1504 may enable a user to control audio of the communication session 300, 400, 500. The mute selection 1524 may mute the audio of the communication session 300, 400, 500. The audio control 1550 may enable a user to adjust audio include volume, levels, and other audio characteristics of the communication session 300, 400, 500.

In an example embodiment, the selections 1510-1524 and controls 1518, 1550 may be implemented on the communication devices 102.1-102.n with soft and/or hard keys.

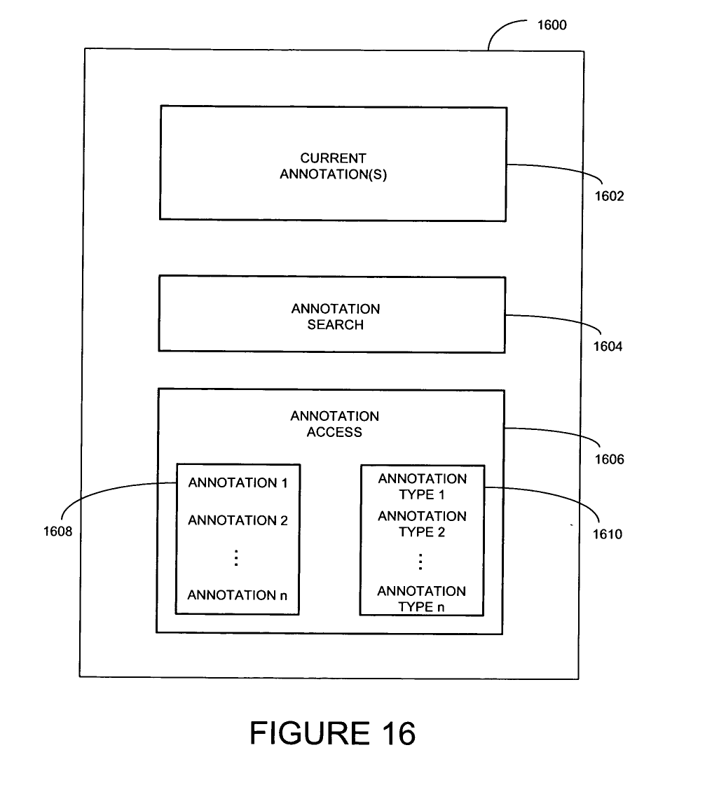

Referring to FIG. 16, an annotation window 1600 in accordance with an example embodiment is illustrated. In an example embodiment, the functionality of the annotations window 1408 and/or the annotations window 1508 (see FIGS. 14 and 15) may include the functionality of the annotation window 1600. The annotation window 1608 may include a current annotations window 1602, an annotation search window 1604 and annotation access window 1606.

The current annotations window 1602 may list the annotations 404, 504.1-504.n contained within the communication session 300, 400, 500 (see FIGS. 3-5). In an example embodiment, the annotations 404, 504.1-504.n may be identified as being provided by a particular user, communication device 102, 202, 203 or terminal 112 (see FIG. 1).

The annotation search window 1604 may enable a user to search for particular annotations 404, 504.1-504.n (see FIGS. 4 and 5) within the communication session 400, 500. For example, the user may specify particular annotations 404, 504.1-504.n by annotation name and annotation type within the annotation search window 1604. In an example embodiment, the identified annotations 404, 504.1-504.n may be provided in the annotation access window 1606.

The annotation access window 1606 may enable a user to jump to portions of the communication session 400, 500 by selecting an annotation or annotation type from the annotations window 1608 and an annotations type window 1610.

For example, if during a fist a communication session a discussion occurs regarding a topic a, a topic b, and a topic c and during a second communication session a discussion occurs regarding the topic b, the topic c, a topic d and a topic e, a user can search over a number of communication sessions including the first communication session 400, 500 and the second communication session 400, 500 by use of the annotation search window 1604 to locate communication sessions that include the topic b and the topic c and review portions of the communication sessions 400, 500 relating to the topic b and the topic c. The user may also jump to portions of the communication sessions 400, 500 that relate to the topic b and the topic c by use of the annotation access window 1606.

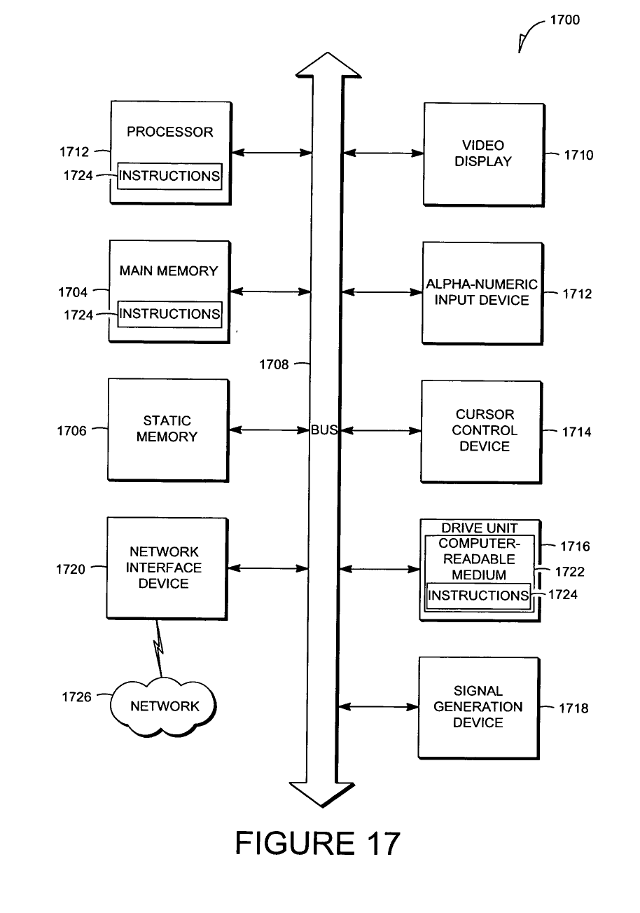

FIG. 17 shows a diagrammatic representation of machine in the example form of a computer system 1700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1712 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard), a user interface (UI) navigation device 1714 (e.g., a mouse), a disk drive unit 1716, a signal generation device 1718 (e.g., a speaker) and a network interface device 1720.

The disk drive unit 1716 includes a machine-readable medium 1722 on which is stored one or more sets of instructions and data structures (e.g., software 1724) embodying or utilized by any one or more of the methodologies or functions described herein. The software 1724 may also reside, completely or at least partially, within the main memory 1704 and/or within the processor 1712 during execution thereof by the computer system 1700, the main memory 1704 and the processor 1712 also constituting machine-readable media.

The software 1724 may further be transmitted or received over a network 1750 via the network interface device 1720 utilizing any one of a number of well-known transfer protocols (e.g., HTTP).

While the machine-readable medium 1722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

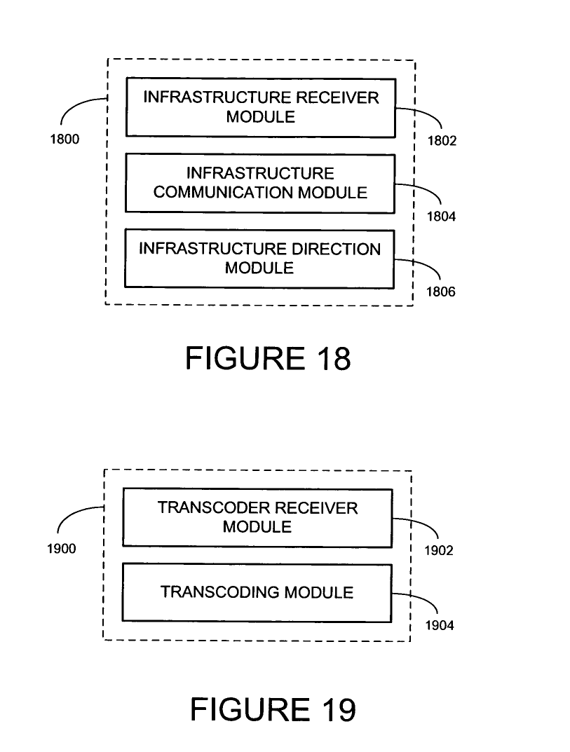

Referring to FIG. 18, a communications infrastructure 1800 according to an example embodiment is illustrated. In an example embodiment, the functionality of the communications infrastructure 106 and/or the communications infrastructure 206 may include the functionality of the communications infrastructure 1800 (see FIGS. 1 and 2). For example, the communications infrastructure 1800 is shown to include one or more infrastructure receiver modules 1802, one or more infrastructure communication modules 1804, and one or more infrastructure direction modules 1806.

The infrastructure receiver module 1802 may receive the plurality of communication streams 302.1-302.n, 402.1-402.n, 502.1-502.n of the communication session 300, 400, 500 from the plurality of communication devices 102.1-102.n, 202.1-202.n (see FIGS. 1-5).

The infrastructure communication module 1804 may provide the plurality of communication streams 302.1-302.n, 402.1-402.n, 502.1-502.n to the transcoder 108, 208 (see FIGS. 1 and 2).

Then infrastructure direction module 1806 may direct the plurality of communication streams 302.1-302.n, 402.1-402.n, 502.1-502.n including at least one transcoded communication stream 302, 402, 502 of the communication session to a target (e.g., a communication device of the communication session 300, 400, 500, a communication device not of the communication session 300, 400, 500, and the network appliance 110, 210). For example, the infrastructure direction module 1806 may provide the plurality of communication streams 302.1-302.n, 402.1-402.n, 502.1-502.n directly or through the transcoder 108, 208.

Referring to FIG. 19, a transcoder 1900 according to an example embodiment is illustrated. In an example embodiment, the functionality of the transcoder 108 and/or the transcoder 208 may include the functionality of the transcoder 1900 (see FIGS. 1 and 2). For example, the transcoder 1900 is shown to include one or more transcoder receiver modules 1902 and one or more transcoding modules 1904.

The transcoder receiver module 1902 may receive the plurality of communication streams 302.1-302.n, 402.1-402.n, 502.1-502.n from the communications infrastructure 106, 206 (see FIGS. 1 and 2).

The transcoding module 1904 may identify a first communication stream type from the plurality of communication streams 302.1-302.n, 402.1-402.n, 502.1-502.n and/or transcode the plurality of communication streams 302.1-302.n, 402.1-402.n, 502.1-502.n from the first communication stream type to a second communication stream type.

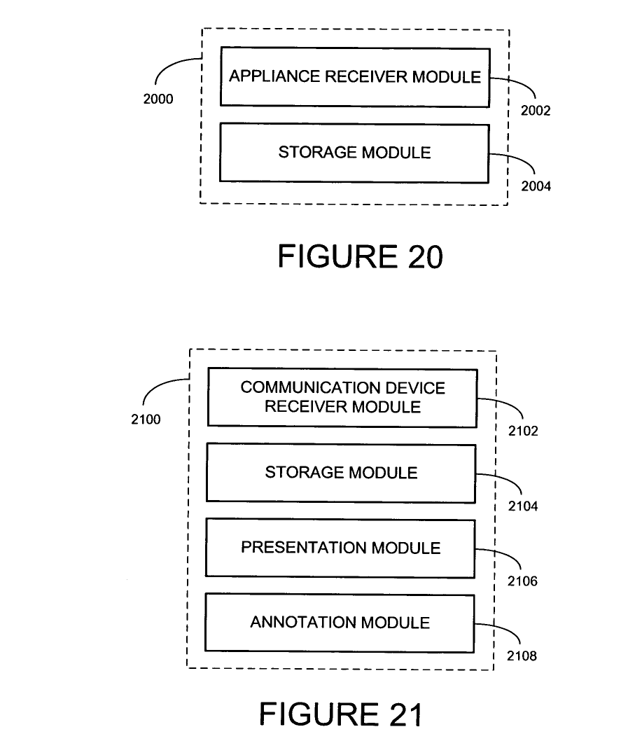

Referring to FIG. 20, a network appliance 2000 according to an example embodiment is illustrated. In an example embodiment, the functionality of the network appliance 110 and/or the network appliance 210 may include the functionality of the network appliance 2000 (see FIGS. 1 and 2). For example, the network appliance 2000 is shown to include one or more appliance receiver modules 2002 and one or more storage modules 2004.

The appliance receiver module 2002 may receive the plurality of communication streams 302.1-302.n, 402.1-402.n, 502.1-502.n of the communication session 300, 400, 500 (see FIGS. 3-5).

The storage module 2004 may store the plurality of communication streams 302.1-302.n, 402.1-402.n, 502.1-502.n in a nonaggregated form (e.g., each communication stream 302, 402, 502 is stored) in a data format such as a transcoded format, an original stream format, and/or a default storage format.

Referring to FIG. 21, a communication device 2100 according to an example embodiment is illustrated. In an example embodiment, functionality of the plurality of communication devices 102.1-102.n, 202.1-202.n and/or the communication device 600 (see FIGS. 1, 2 and 6) may include the functionality of the communication device 2100. For example, the controller 602 (see FIG. 6) may include the functionality of the communication device 2100. In an example embodiment, communication device 2100 may be a STB.

As shown, the communication device may include one or more communication device receiver modules 2102, one or more recording modules 2104, one or more storage modules 2106, one or more presentation modules 2108, and one or more annotation modules 2110.

The communication device receiver module 2102 may receive the plurality of communication streams 302.1-302.n, 402.1-402.n, 502.1-502.n of the communication session 300, 400, 500 (see FIGS. 3-5).

The storage module 2104 may store the plurality of communication streams 302.1-302.n, 402.1-402.n, 502.1-502.n in a nonaggregated form (e.g., each communication stream 302, 402, 502 is stored) in a data format such as a transcoded format, an original stream format, and/or a default storage format.

The presentation module 2106 may present one or more selected communications streams from the plurality of communication streams 302.1-302.n, 402.1-402.n, 502.1-502.n of the communication session 300, 400, 500. For example, the one or more selected communication streams may be provided to a display device (e.g., a television) for presentation to a user.

The annotation module 2108 may receive annotations from the user and/or present annotations to the user. For example, the annotations may be presented on the display device for display to a user.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
identifying a first content type for a selected communication stream associated with a plurality of communication streams from a nonaggregated communication session;
identifying a target of the selected communication stream;
transcoding the selected communication stream into a second content type compatible with the target; and
providing the transcoded communication stream of the nonaggregated communication session to the target.

2. The method of claim 1, further comprising representing the first content type and the second content type to be at least one content type selected from a group of content types that include a data format and a protocol associated with the communication stream.

3. The method of claim 1, further comprising identifying semantic information regarding the nonaggregated communication session in the communication stream.

4. The method of claim 1, further comprising selecting available communication streams from the plurality of communication streams associated with the communication session stored on a single device as the nonaggregated communication session.

5. A method comprising:
invoking a transcoder to transcode a communication stream from a target; and
receiving a transcoded communication stream associated with a communication session and annotations regarding the communication session.

6. The method of claim 5, further comprising:
accessing a target communication stream from the target of the communication session; and
providing a source communication stream within the communication session to the target.

7. The method of claim 5, further comprising:
storing available communication streams and the annotations of the communication session.

8. The method of claim 5, further comprising annotating at least one communication stream from available communication streams of the communication session.

9. The method of claim 5, further comprising selecting at least one data type selected from a group of data types including metadata, hyperlinks, chapter headings, topics, and audio as being the annotations used within the communication session.

10. The method of claim 9, further comprising selecting a position in available communication streams for playback by selecting a particular annotation from the annotations used within the communication session.

11. The method of claim 10, further comprising selecting a customized experience in response to the annotations and in connection with the available communication streams.

12. The method of claim 5, further comprising parsing and categorizing the communication session using the annotations.

13. The method of claim 5, further comprising branching to portions of the communication session by use of the annotations.

14. A system comprising:
a communications infrastructure comprising:
an infrastructure receiver module to receive a plurality of communication streams of a communication session from a plurality of communication devices,
an infrastructure communication module to provide the plurality of communication streams to a transcoder, and
an infrastructure direction module to direct the plurality of communication streams including at least one transcoded communication stream of the communication session to a target; and
a transcoder comprising:
a transcoder receiver module to receive the plurality of communication streams from the communications infrastructure, and
a transcoding module to identify a first communication stream type from the plurality of communication streams and transcode the plurality of communication streams from the first communication stream type to a second communication stream type.

15. The system of claim 14, wherein the communications infrastructure comprises an Internet Protocol (IP) communications infrastructure with session initiation protocol (SIP) capability.

16. The system of claim 14, wherein the target includes at least one device selected from a group of devices including a selected communication device of the plurality of communication devices, a communication device different from any of the plurality of communication devices, and a network appliance.

17. The system of claim 14, further comprising a network appliance comprising:
a receiver module to receive the plurality of communication streams of the communication session, and.
a storage module to store the plurality of communication streams in an nonaggregated form on storage in at least one data format selected from a group of data formats including a transcoded format, an original stream format, and a default storage format on the storage.

18. The system of claim 14, wherein the plurality of communications devices includes at least one resource selected from a group of resources including a computing system, a mobile telephone, a personal digital assistant (PDA), a gaming device, a set top box (STB), a standard single line telephone, a multi-line telephone, and a video phone.

19. A method comprising:
initiating a nonaggregated communication session with a plurality of communication streams between a signal source and one or more targets;
transcoding at least one of the plurality of communication streams of the nonaggregated communication session; and
providing at least one communication stream selected from a group including a nontranscoded communication stream and a transcoded communication stream associated with the plurality of communication streams of the nonaggregated communication session between the signal source and the one or more targets.

20. The method of claim 19, further comprising recording the nonaggregated communication session.

21. The method of claim 19, further comprising selecting at least one session type selected from a group of session types including a lecture, a conversation, a conference between two or more parties, a performance, and instant messaging as being the communication session.

22. A machine-readable medium comprising instructions, which when executed by a machine, cause the machine to:
initiate a nonaggregated communication session with two or more communication streams between a signal source and one or more targets;
transcode at least one of the two or more communication streams of the nonaggregated communication session; and
provide the communication streams of the nonaggregated communication session between the signal source and the one or more targets.

23. The instructions of claim 22 further comprising instructions to record the nonaggregated communication session.

24. An apparatus comprising:
a communication device receiver module to receive a plurality of communication streams of a communication session; and
a storage module to store the plurality of communication streams in a nonaggregated form.

25. The apparatus of claim 24, further comprising:
a presentation module to present a selected communication stream from the plurality of communication streams of the communication session to a display device for display to a user.

26. The apparatus of claim 24, further comprising:
an annotation module to perform at least one of receiving annotations from a user or presenting the annotations to the user.

27. The apparatus of claim 24, wherein the apparatus is a set-top box (STB).
